(19) United States
(12) Patent Application Publication
(10) Pub. No.: US 2026/0218893 A1
(43) Pub. Date: Jul. 30, 2026

(54) Optical system with heatproof effect module and stage light fixture with same

(71) Applicant: Guangzhou Haoyang Electronic Co., Ltd., Guangzhou (CN)

(72) Inventors: Weikai JIANG, Guangzhou (CN); Xiaoxue CHEN, Guangzhou (CN); Mingjian YUAN, Guangzhou (CN); Yong HU, Guangzhou (CN)

(21) Appl. No.: 19/431,284

(22) Filed: Dec. 23, 2025

(30) Foreign Application Priority Data
Jan. 25, 2025 (CN) 202520174095.2
Aug. 12, 2025 (CN) 202521719991.9
Aug. 29, 2025 (CN) 202511234895.X

(51) Int. Cl. F21V 29/502; F21V 5/00; F21V 7/24; F21V 7/28; F21V 14/00; F21V 14/08; F21V 29/70; F21V 29/85; F21V 29/89; F21W 131/406

(52) U.S. Cl. CPC F21V 29/502; F21V 5/008; F21V 7/24; F21V 7/28; F21V 14/006; F21V 14/08; F21V 29/70; F21V 29/86; F21V 29/89; F21W 2131/406

(57) ABSTRACT

An optical system includes a light source for emitting a light beam; at least one effect module including an effect part configured to at least partially switch into and out of the light beam to shape the light beam, which has a light-facing surface, close to the light source, with a reflectivity of at least 70%; a lens module for changing a divergence angle of the light beam; and a light outgoing lens for projecting light spots formed by the shaped light beam.

### CROSS REFERENCE TO RELATED APPLICATIONS

The present application claims priority from Chinese Application No. CN 202520174095.2 filed on Jan. 25, 2025, Chinese Application No. CN 202521719991.9 filed on Aug. 12, 2025, and Chinese Application No. CN 202511234895.X filed on Aug. 29, 2025, all of which are hereby incorporated herein by reference.

### TECHNICAL FIELD

The present disclosure relates to the technical field of stage light fixtures, and in particular, to an optical system with a heatproof effect module and a stage light fixture with the same.

### BACKGROUND

Multi-functional stage light fixtures usually integrate a variety of lighting effects. For example, the light beam emitted from the light source is typically shaped by various effect modules internally provided, and finally form light spots with particular shapes which are projected onto a target plane through a lens module, thereby creating atmosphere and producing unique stage effects. With increasing market demands for high-power stage light fixtures, the light source for stage light fixtures is inclined to be high-power LEDs and laser light source, which would generate a considerable amount of heat. Consequently, the effect modules will expose to high-temperature environment during operation. The existing effect modules, however, are prone to deformation or even cracking due to long-term heating.

### SUMMARY

The present disclosure therefore provides an optical system with a heatproof effect module and a stage light fixture with the same, which is free from the problem mentioned above.

The optical system of the present disclosure includes a light source for emitting a light beam; at least one effect module including an effect part configured to at least partially switch into and out of the light beam to shape the light beam, which has a light-facing surface, close to the light source, with a reflectivity of at least 70%, and a backlight surface away from the light source; a lens module for changing a divergence angle of the light beam; and a light outgoing lens for projecting light spots formed by the shaped light beam.

According to the present disclosure, when the effect part of the effect module is switched into the light beam, portion of the light beam is allowed to pass through the light transmitting portion of the effect part and irradiates to the lens module, which is finally projected onto the target plane by the light outgoing lens. As the light-facing surface of the effect part has the reflectivity of at least 70%, the portion of the light beam blocked by the effect part is mostly reflected by the light-facing surface in time, so as to prevent a large amount of light from irradiating to the effect part, thereby avoiding heat accumulation thereon. Such configuration thus can enhance the high-temperature resistance of the effect part, enables the effect part to maintain an ideal operating temperature in the high-temperature environment, and ensures operating accuracy and service life. In addition, such configuration can also meet the heat dissipation requirement of the effect module with the cooling fan provided for cooling the effect module reduced or eliminated. This can further reduce noise and effectively save size of the effect module.

In a preferable embodiment of the present disclosure, the effect part includes a substrate, the light-facing surface is defined by the side of the substrate close to the light source, the light-facing surface has an effect area for shaping the light beam, and the effect area is formed with a light non-transmitting portion for intercepting a portion of the light beam and a light transmitting portion for passing other portion of the light beam. In addition, the substrate corresponding to the light non-transmitting portion is provided with a plurality of reflecting units for at least partially reflecting light rays of the light beam and/or heat, the reflecting units are at least partially extended onto the light-facing surface form the substrate to reflect the light rays together with the substrate, and a reflectivity of each reflecting unit is greater than a reflectivity of the substrate.

The light beam emitted by the light source usually includes visible light of different wave bands and infrared light. During shaping of the light beam, the visible light generates various light effects, which are finally presented to the audiences, while the infrared light is the primary cause of temperature rise of the effect part. In this case, the light transmitting portion allows a portion of the light beam to pass through to form specific light effects, and the light non-transmitting portion intercepts the other portion of the light beam. The portion of the light beam intercepted by the light non-transmitting portion or the heat thereof, i.e. radiant energy, is reflected by the reflecting units exposed to the surface of the effect part. This avoids the effect part from absorbing excessive heat, so as to maintain the effect part in a stable temperature, thereby preventing deformation and cracking of the effect part due to high temperature, achieving optimal working state, and ensuring clear projection of light spots. In addition, with the reflecting units extended onto the surface of the effect part form the substrate, the reflecting units can be firmly inserted into the substrate. In this way, the rest of the reflecting unit can continuously reflect light, even if the reflecting unit is partially detached. Therefore, the reflecting unit in such configuration has high stability and is not easy to lose effect. In this case, the problem of excessive temperature rise of the effect part can be fundamentally solved by means of reflection, without changing the size of the effect part to increase the heat dissipation area, and without adding a high-power fan for heat dissipation, thereby reducing the space occupied by the effect module.

Furthermore, to effectively reflect most of the light intercepted and/or heat, the reflectivity of the reflecting units is at least 90%.

In a particular embodiment of the present disclosure, the substrate is recessed from the light-facing surface to the backlight surface to form a plurality of accommodating holes, and the plurality of reflecting units are respectively received in the plurality of accommodating holes. With the intentional design of the accommodating holes according to the distribution of the light intensity, the reflecting units in this case can be pointedly distributed in the area having high light intensity, thereby achieving improved reflecting efficiency.

Preferably, the reflecting units are in form of particles and are evenly distributed over the entire substrate. In such configuration, the reflecting units can be processed and shaped with the substrate by mixing the particles into the substrate, without secondary processing, thereby reducing processing procedures and improving processing efficiency.

Metal material itself has a certain degree of reflection. Therefore, the substrate is preferably made of metal materials having a reflectivity of not less than 30%. In combination with the reflecting units, the effect part in this case has improved reflectivity for the light and/or heat, so that the effect part will not absorb excessive light or heat.

Additionally, the reflecting units are made of materials including at least one of titanium dioxide, zirconia, aluminum oxide, or silica. Such materials are white powders with very high melting point, which have extremely high reflectance for visible light, good thermal stability, and stable performance even under high temperature.

In order to diffusely reflect the blocked light beam in multiple directions to different places, the light-facing surface may be in form of a rough surface according to a preferable embodiment of the present disclosure. In such easy way, the light beam intercepted by the effect part can be diffusely reflected to different places to effectively avoid re-concentration of the reflected light on a certain point.

According to the present disclosure, the effect module may include a gobo wheel, and the effect part is correspondingly formed by a plurality of gobos. In such case, when the gobo is selectively switched into the light path and only allows the light beam to pass though the pattern formed in the gobo, so as to form light spots with specific patterns, shapes, or images which are projected onto the target plane by the light outgoing lens.

According to the present disclosure, the effect module may include a fire wheel assembly, and the effect part is correspondingly formed by a dynamic fire wheel. In such case, at least portion of the dynamic fire wheel is switched into the light path to form light spots with vivid pattern effects such as flame effect or water flow effect.

According to the present disclosure, the effect module may also include an aperture assembly, and the effect part is correspondingly formed by a plurality of aperture blades. In such case, the plurality of aperture blades in combination can form apertures in different diameters, so that the size of the light spots can be adjusted, as well as the brightness of the light spots, which achieves more complex light effects for different scenes.

In an advantageous embodiment of the present disclosure, the effect part may include a substrate and a reflective layer arranged on a side of the substrate close to the light source, and the light-facing surface is defined by a side of the reflective layer close to the light source. In this case, the effect part is provided with an independent reflective layer, which facilitates processing.

To avoid adverse influence on the reflectivity due to thinner thickness of the reflective layer, and poor light effects due to thicker thickness of the reflective layer, the thickness of the reflective layer preferably ranges from 10 μm to 100 μm.

As most of light rays of the light beam are reflected by the light-facing surface to other spaces for heat dissipation, strict requirement for the high-temperature resistance of the substrate is not needed in the present disclosure, making it possible to use materials in lower cost and easier to process. Therefore, the substrate in the present disclosure may be made of metal material or ceramic material.

Preferable, the reflective layer is made of materials including at least one of barium sulfate, magnesium oxide, or polytetrafluoroethylene.

Due to difference in thermal expansion property between the substrate and the reflective layer, a flexible adhesive layer may be provided between the substrate and the reflective layer. The flexible adhesive layer can provide transition and buffering for the expansion of the substrate and the reflective layer during high-temperature operation.

Furthermore, the effect part may further include a heat dissipation layer with an emissivity of at least 85% for an infrared band, which is arranged on a side of the substrate away from the light source. Such configuration can enhance the thermal radiation heat dissipation of the side of the effect part away from the light source, which facilitates quick decrease of the temperature on the substrate, and reduces the reliance on active cooling devices such as fans, thereby lowering power consumption and noise caused by the cooling devices.

More preferably, as higher reflectivity can greatly reduce accumulation of light rays on the light-facing surface of the effect part, the reflectivity of the light-facing surface in the present disclosure is preferably greater than 80%.

During use, external light may enter the system through the light outgoing lens and may be further reflected on the backlight surface of the effect part, which may cause glare. Therefore, the backlight surface at the side of the effect part away from the light source preferably has glossiness lower than 5 GU. The backlight surface with specific glossiness can effectively reduce glare to ensure light effects of the optical system.

According to a preferable embodiment of the present embodiment, the effect module may include a light shading assembly, and the effect part is correspondingly defined by a plurality of light shading blades arranged close to a focal point of the light beam. Particularly, the light shading assembly may include a mounting plate with a light-passing hole, at least three light shading blades arranged around the light-passing hole, and a driving module configured to drive the light shading blades to switch into or out of the light-passing hole. In such configuration, the light shading blades cooperate to block the light beam from various angles to form light spots in various shapes, thereby enriching the light effects of the optical system.

Furthermore, the light beam may be in a frustum shape, and the light shading blades may be arranged on a side of the mounting plate close to the light source. In this case, the light shading assembly may further include a plate with a first hollow hole and a separator configured to restrict movement of the light shading blades in a direction perpendicular to a plane where the light shading blades are located. The plate is arranged on the side of the separator close to the light source and in the imaging plane of the light beam, the separator is provided with a second hollow hole for the light beam to pass through, and an opening area of the second hollow hole is 97% to 120% of a cross-sectional area of the light beam passing through the second hollow hole. With limiting the opening area of the second hollow hole, the separator will not be excessively switched into the light beam, and can effectively block and absorb the light reflected by the light-facing surface of the light shading blades, which avoids the light from being reflected back to the plate and then reflected again into the light beam to form stray light.

The present disclosure further provides a stage light fixture, including a light head with a light outlet and the optical system in any case mentioned above. The optical system is arranged in the light head, with the light source installed at an end of the light head away from the light outlet, and the light outlet covered by the light outgoing lens.

With such optical system, portion of the light beam with excessively high temperature can be reflected by the light-facing surface of the effect part to various places inside the light head, so that the temperature inside the light head can be evenly distributed, and the heat inside the light head can be dissipated to the outside through the side wall of the light head, thereby achieving improved heat dissipation effect. The effect module with improved high-temperature resistance can operate normally in the light beam generated by the light source at full power, so that there is no need to protect the effect module by reducing the power of the light source, especially in a case that the light source has larger power.

### BRIEF DESCRIPTION OF THE DRAWINGS

FIG. 1 is a schematic diagram of an optical system according to an embodiment of the present disclosure;

FIG. 2 is a schematic cross-sectional view of an effect part according to an embodiment of the present disclosure.

FIG. 3 is an exploded view of a light shading assembly according to an embodiment of the present disclosure.

FIG. 4 is a schematic diagram of an effect part having reflecting units according to an embodiment of the present disclosure;

FIG. 5 a schematic diagram of an effect part having reflecting units according to another embodiment of the present disclosure;

FIG. 6 is detailed view of part A in FIG. 5;

FIG. 7 is a view showing an internal structure of a light head with a heatproof effect module according to an embodiment of the present disclosure; and

FIG. 8 is a detailed view of part A in FIG. 7.

### DETAILED DESCRIPTION OF THE EMBODIMENTS

The accompanying drawings are merely for illustrative purposes and should not be construed as limiting this patent. In order to better illustrate this embodiment, some components in the accompanying drawings may be omitted, enlarged or reduced, and do not represent the actual size of a product. For those skilled in the art, it is understandable that some well-known structures and their descriptions may be omitted in the accompanying drawings. The positional relationships described in the accompanying drawings are merely for illustrative purposes and should not be construed as limiting this patent.

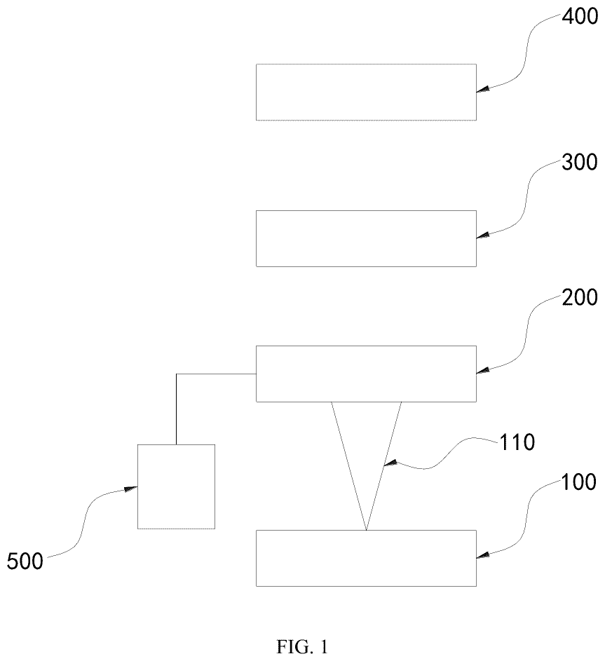

FIG. 1 provides an optical system according to an embodiment of the present disclosure, having a light source 100 for emitting a light beam 110. In the optical system of the present embodiment, at least one effect module 200, a lens module 300, and a light outgoing lens 400 are sequentially arranged along the propagating direction of the light beam 110. The effect module 200 is provided at least one effect part 210 that can be at least partially selectively switched into the light beam 110 to generate light effects by partially intercepting the light beam, the side of the effect part 210 close to the light source 100 is indicated as a light-facing surface 211, and the reflectivity of the light-facing surface 211 is preferably at least 70%. The side of the effect part 210 away from the light source 100 is indicated as a backlight surface 212.

According to this embodiment, when the effect part 210 is switched into the light beam 110, portion of the light beam 110 passes through the light transmitting portion of the effect part 210 and irradiates to the lens module 300, which is finally projected onto the target plane by the light outgoing lens 400. Due to at least 70% reflectivity of the light-facing surface 211 of the effect part, the portion of the light beam 110 blocked by the effect part is mostly reflected by the light-facing surface 211 in time, which prevents a large amount of light from irradiating to the effect part, thereby avoiding heat accumulation thereon. Such configuration thus enhances the high-temperature resistance of the effect part, thereby enabling the effect part to maintain an ideal operating temperature in the high-temperature environment and ensuring operating accuracy and service life. In addition, such configuration can also meet the heat dissipation requirement of the effect module 200 with the cooling fan 720 provided for cooling the effect module 200 reduced or eliminated, which further reduces noise and effectively saves size of the effect module 200.

In order to project clear light spots, the effect module 200 in the present embodiment is arranged close to a focal point of the light beam 110.

The lens module 300 in the present embodiment may be a magnifying lens assembly or a focusing lens assembly.

In order to effectively reduce wear and tear, and corrosion of the effect part due to oxygen isolation, the light-facing surface 211 in the present embodiment is further coated with an oxidation resistant layer with a visible light transmittance greater than 95%.

A driving module 500 is further provided in the present embodiment for driving the effect part 210 to switch into or out of the light beam 110. In this easy way, the effect part 210 can be switched into or out of the light beam 110 by the driving module 500 according to actual demand, providing flexible controllability of the effect module 200.

Particularly, the driving module 500 includes a motor for providing a driving force.

In a preferred embodiment of the present disclosure, the light-facing surface 211 is formed in a rough surface for diffusely reflecting the light beam 110, so that the light-facing surface 211 can diffusely reflect the received light beam 110 in multiple directions to different places, thereby effectively avoiding re-concentration of the reflected lights on a certain point.

In other embodiments of the present disclosure, the light-facing surface 211 may be a smooth surface, which can also reflect light to prevent excessive lights from concentrating on the surface of the effect part 210 and being absorbed by the effect part 210.

In some embodiments, the effect module 200 is a gobo wheel and the effect part 210 is a gobo. In such cases, when the gobo is switched into the light path and only allows the light beam to pass though the pattern formed in the gobo, so as to form light spots with specific patterns, shapes, or images which are projected onto the target plane by the light outgoing lens 400.

In other embodiments, the effect module 200 is a fire wheel assembly for providing flame effect and the effect part 210 is correspondingly a dynamic fire wheel. In such cases, at least portion of the dynamic fire wheel is switched into the light path to form light spots with vivid pattern effects such as flame effect or water flow effect.

In other embodiments, the effect module 200 is an aperture assembly and the effect part 210 correspondingly includes a plurality of aperture blades. In such cases, the plurality of aperture blades in combination form apertures in different diameters, so that the size of the light spots can be adjusted, as well as the brightness of the light spots, which achieves more complex light effects for different scenes.

Particularly, in a case that the effect module 200 is a gobo wheel or the fire wheel, the effect part has a light transmitting portion for part of the light beam 110 to pass through and a light non-transmitting portion for blocking other part of the light beam 110. In such case, the reflectivity of the light-facing surface 211 corresponding to the light non-transmitting portion is greater than or equal to 70%, and the transmittance of the light transmitting portion is unchanged. This will not affect light effects while effectively improving the high-temperature resistance of the effect part. In a case that the effect module 200 is the aperture assembly or a light shading assembly 600, the effect part 210 mainly adjusts the size and shape of the light spot by shading a portion of light beam. In such case, the reflectivity of the light-facing surface 211 of the whole effect part is at least 70%.

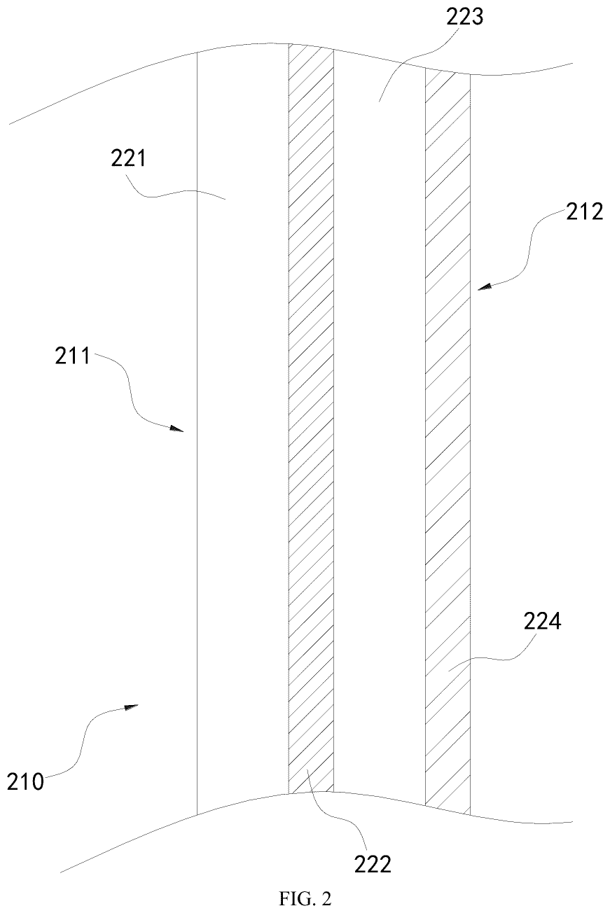

FIG. 2 shows an effect part according to a preferable embodiment, the effect part in this embodiment includes a substrate 223 and a reflective layer 221 arranged on the side of the substrate 223 close to the light source 100, and the side of the reflective layer 221 close to the light source 100 defines the light-facing surface 211. It is easy to process by independently arranging the reflective layer 221.

In an alternative embodiment, the light-facing surface 211 having the ability of reflecting the light beam may be directly formed on the surface of substrate 223.

The reflective layer 221 is preferably an organic coating or a nano-material coating.

The reflective layer 221 is made of materials including at least one of barium sulfate, magnesium oxide, or polytetrafluoroethylene.

The thickness of the reflective layer 221 preferably ranges from 10 μm to 100 μm. The reflectivity of the reflective layer 221 will not meet the requirement if the thickness of the reflective layer 221 is too thin, and poor light effects will be obtained if the thickness of the reflective layer 221 is too thick.

More preferably, the substrate 223 is made of a metal material, such as pure copper, copper alloy, aluminum alloy, and nickel-based alloy, or a ceramic material. Most of light rays of the light beam are reflected by the light-facing surface 211 to other spaces for heat dissipation, so strict requirement for the high-temperature resistance of the substrate 223 is not needed, making it possible to use materials in lower cost and easier to process.

The substrate 223 is particularly made of copper material, especially red copper material, which is a moderately priced and has good thermal conductivity.

As shown in FIG. 2, a flexible adhesive layer 222 in the present embodiment is further provided between the substrate 223 and the reflective layer 221. A difference in thermal expansion property usually exists between the substrate 223 and the reflective layer 221, the flexible adhesive layer 222 provides transition and buffering for the expansion of the substrate 223 and the reflective layer 221 during high-temperature operation.

The flexible adhesive layer 222 is preferably an organic adhesive with thickness ranging from 10 μm to 20 μm.

Furthermore, a heat dissipation layer 224 with an emissivity of at least 85% for an infrared band is further included, which is arranged on the side of the substrate 223 away from the light source 100. Such arrangement enhances the thermal radiation heat dissipation effect of the side of the effect part 210 away from the light source 100, facilitating quick decrease of the temperature on the substrate 223, and reducing the reliance on active cooling devices such as fans, thereby lowering power consumption and noise caused by the cooling devices.

As the higher reflectivity greatly reduces the accumulation of light rays on the light-facing surface 211 of the effect part, the reflectivity of the light-facing surface 211 in the present embodiment is preferably greater than 80%. This significantly enhances its high-temperature resistance.

The glossiness of the backlight surface 212 is preferably lower than 5 GU. During use, external light may enter the system through the light outgoing lens 400 and may be reflected on the backlight surface 212 of the effect part 210, which will cause glare. However, the backlight surface 212 with specific glossiness can effectively reduce glare, thereby ensuring light effects of the optical system.

Particularly, lower glossiness brings better effect, the glossiness reduction of the backlight surface 212 of the effect part can be achieved by spraying black sand, e.g., spraying organic resin or inorganic nano-paint, or by oxidation blackening.

More preferably, the glossiness of the heat dissipation layer 224 is 1 GU, with reflectivity for a visible light band lower than 15%, and thickness ranging from 5 μm to 30 μm. Such configuration can achieve a more efficient radiated heat dissipation effect.

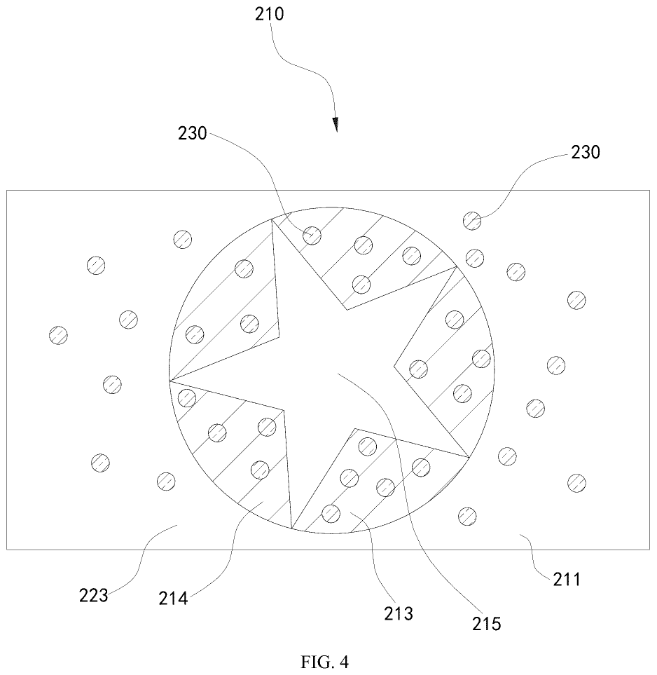

In a preferred embodiment of the present disclosure, the effect module 200 is in form of a light shading assembly 600, as shown in FIG. 4, and the effect part 210 in this embodiment is a plurality of light shading blades 620, and the light shading assembly 600 is arranged close to a focal point of the light beam 110.

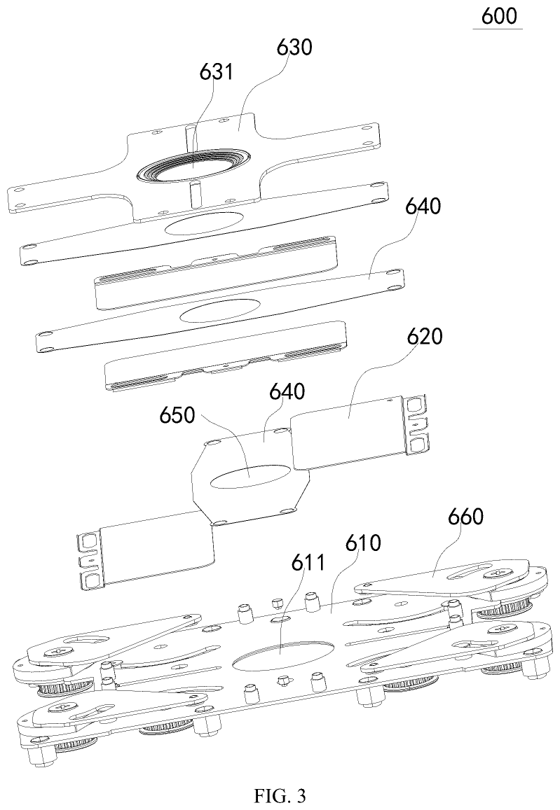

Referring to FIG. 3, the light shading assembly 600 particularly includes a mounting plate 610 having a light-passing hole 611, at least three light shading blades 620 arranged around the light-passing hole 611, and a driving module 500 configured to drive the light shading blades 620 to switch into or out of the light-passing hole 611. By combining the plurality of light shading blades 620 at various angles, the light beam 110 is partially shaded to form light spots in various shapes, thereby enriching the light effects of the optical system.

In this embodiment, four light shading blades 620 around the light-passing hole 611 are provided. As shown in FIG. 3, the driving module 500 particularly includes a motor (not shown) providing a driving force and a transmission arm 660 configured to transmit the driving force to the corresponding light shading blade 620. Under driving of the motor and the transmission arm 660, the light shading blades 620 are switched into the light-passing hole 611 at various specific angles to form light spots with specific shapes.

In a more preferred embodiment of the present disclosure, the light beam 110 is in a frustum shape, and the plurality of light shading blades 620 are located on the side of the mounting plate 610 close to the light source 100. The light shading assembly 600 further includes a plate 630 with a first hollow hole 631, and a separator 640 configured to restrict the movement of the light shading blade 620 in a direction perpendicular to a plane where the light shading blade is located. The plate 630 is located on the side of the separator close to the light source 100 and in an imaging plane of the light beam 110, namely the plane where the focal point of the light beam 110 is located. The separator is provided with a second hollow hole 650 for the light beam 110 to pass through, and an opening area of the second hollow hole 650 is 97% to 120% of a cross-sectional area of the light beam 110 passing through the second hollow hole 650. Limiting an opening area of the second hollow hole 650 can not only prevent the separator from excessively switching into the light beam 110, but also effectively block and absorb the light reflected by the light-facing surface 211 of the light shading blades 620, thereby avoiding the light from being reflected back to the plate 630 and then reflected again into the light beam 110 to form stray light. Preferably, opening area of the second hollow hole 650 close to the lower limit, better anti-glare effect will be achieved.

The opening area of the first hollow hole 631 is preferably smaller than that of the second hollow hole 650.

An inner side wall of the first hollow hole 631 is preferably provided with a multi-circle stepped anti-glare structure.

In the case that the effect module 200 is in form of a light shading assembly 600, the operating temperature of the heatproof light shading assembly 600 according to the embodiment of the present disclosure and the existing light shading assembly 600 is respectively listed in the table below, with or without an auxiliary fan for heat dissipation. Comparison results of heatproof light shading assembly and existing light shading assembly

| If Auxiliary fan is | | |
|---|---|---|
| provided for | | Heatproof light shading |
| auxiliary heat | Existing light | assembly according to |
| dissipation | shading assembly | the present disclosure |
| Yes | 510° C. | 130° C. |
| No | 670° C. | 210° C. |

The results illustrate that the heatproof light shading assembly 600 (210° C.) without auxiliary heat dissipation described in the present disclosure is still significantly superior to the ordinary light shading assembly 600 (510° C.) with auxiliary heat dissipation. Therefore, the effect module 200 of the present disclosure can effectively solve the heat dissipation problem and reduce the operating temperature of the effect module 200, also allow for elimination of the cooling fan for dissipating the effect module 200, which saves the space occupied by the effect module 200 and manufacturing cost, and effectively reduces noise caused by the cooling fan. In addition, since this way effectively reduces the operating temperature of the effect module 200, deformation risk of the substrate 223 of the effect part 210 is also reduced, thereby greatly increasing the reliability of the effect module 200, and the requirement for the deformation resistance of the substrate 223 is further reduced, allowing for use of lower-cost materials.

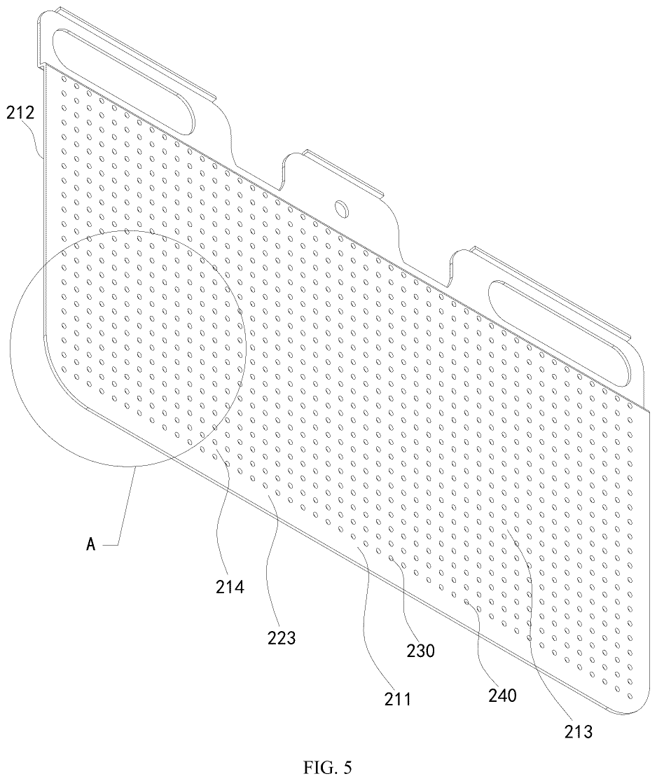

FIG. 4 and FIG. 5 depict an effect part according to another preferable embodiment of the present disclosure. In this embodiment, the effect part 210 includes a substrate 223, the light-facing surface 211 being defined by the side of the substrate 223 close to the light source 100. The light-facing surface 211 has an effect area 213 for shaping the light beam 110, and the effect area 213 is formed with a light non-transmitting portion 214 for intercepting a portion of the light beam 110 and a light transmitting portion 215 for passing the other portion of the light beam 110. In addition, the substrate 223 corresponding to the light non-transmitting portion 214 is provided with a plurality of reflecting units 230 for at least partially reflecting light rays of the light beam and/or heat, the plurality of reflecting units 230 are at least partially extended to the light-facing surface 211 to reflect the light rays together with the substrate 223, and the reflectivity of each reflecting unit 230 is greater than the reflectivity of the substrate 223.

The effect module 200 in this embodiment may be a gobo wheel or a fire assembly, and the effect part may be correspondingly defined by at least one gobo or a fire wheel. The light transmitting portion 215 in this case is defined by the pattern formed on the gobo or the fire wheel. FIG. 4 particularly shows a gobo. The effect module 200 in this embodiment may also be an aperture assembly or a light shading assembly, and the effect part may be correspondingly defined by a plurality of aperture blades or light shading blades. The light transmitting portion 215 in this case is defined by a light passing hole formed by the plurality of aperture blades or light shading blades. FIG. 5 particularly shows a light shading blade.

The light beam 110 emitted by the light source 100 usually includes visible light of different wave bands and infrared light. During shaping of the light beam 110, the visible light generates various light effects, which are finally projected and presented to the audiences, while the infrared light primarily causes temperature rise of the effect part. In this embodiment, the light transmitting portion 215 allows a portion of the light beam to pass through to form specific light effects, and the light non-transmitting portion 214 intercepts the other portion of the light beam. The portion of the light beam 110 intercepted by the light non-transmitting portion 214 or the heat thereof, i.e. radiant energy, is reflected by the reflecting units 230 exposed to the surface of the effect part 210, so that the effect part 210 will not absorb excessive heat and maintains in a stable temperature, thereby preventing deformation and cracking of the effect part 210 due to high temperature, achieving optimal working state, and ensuring clear projection of light spots. In addition, with the reflecting units 230 extended to the surface of the effect part, the reflecting units 230 in this embodiment can be firmly inserted into the substrate 223. In this way, the rest of the reflecting unit 230 can continuously reflect light, even if the reflecting unit 230 is partially detached. The reflecting unit 230 in such configuration thus has high stability and is not easy to lose effect. Accordingly, the problem of excessive temperature rise of the effect part 210 can be fundamentally solved by means of reflection, without changing the size of the effect part 210 to increase the heat dissipation area, and without adding a high-power fan for heat dissipation, thereby reducing the space occupied by the effect module.

The reflecting units 230 in this embodiment may be configured to form diffuse reflection or mirror reflection. However, diffuse reflection is preferable, as diffuse reflection is more suitable for the working environment in the stage light fixture and will not cause temperature rising of other parts due to excessive concentrated reflection of light, or generate stray light.

The reflecting units 230 in this embodiment are preferably evenly distributed in the light non-transmitting portion 214. This allows the light intercepted by the effect part to be evenly reflected by the light non-transmitting portion 214.

In some cases, the reflecting units 230 are distributed over the entire light-facing surface 211 of the effect part 210, especially in the case that the effect part is defined by a plurality of aperture blades or light shading blades.

The reflectivity of the reflecting units 230 in this embodiment is preferably at least 90%. Such reflecting units 230 can to effectively reflect most of the light intercepted and/or heat. More preferably, the reflecting units 230 mainly reflects the light intercepted by the effect part 210.

The total area of the reflecting units is preferably at least 30% to 70% of the area of the light non-transmitting portion 214.

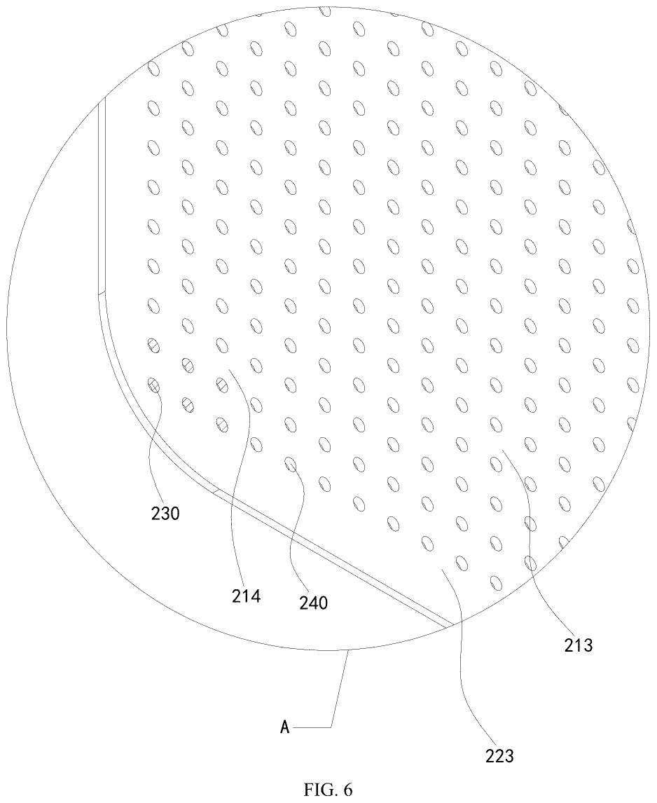

As clearly shown in FIG. 5 and FIG. 6, in order to pointedly distribute the reflecting units according to the distribution of the light intensity, the substrate 223 in this embodiment is recessed from the light-facing surface 211 to the backlight surface 212 to form a plurality of accommodating holes 240, the reflecting units 230 being respectively received in the plurality of accommodating holes 240. The reflecting units in this case thus can be distributed in the area having high light intensity, due to the intentional design of the accommodating holes according to the distribution of the light intensity, thereby achieving improved reflecting efficiency.

According to actual demands, the reflecting units 230 can be flush with the surface of the substrate 223 or slightly protruded from the surface of the substrate 223.

More preferably, the accommodating holes 240 are arranged in an array, especially in a rectangular array.

Preferably, the reflecting units 230, which are formed by curing the power materials, are respectively filled in the accommodating holes 240.

As shown in FIG. 4, in order to reduce processing procedures and improve processing efficiency, the reflecting units 230 are in form of particles and are evenly distributed over the entire substrate 223, especially embedded into the substrate 223. In such configuration, the reflecting units 230 can be processed and shaped with the substrate 223 by mixing the particles into the substrate, without secondary processing.

Preferably, the substrate 223 is a particle-reinforced metal substrate formed by passing through high-temperature metallurgical atmosphere, which can efficiently reflect light and/or heat. For example, metal powder uniformly dispersed ultra-fine particles such as aluminum oxide and zirconium dioxide are uniformly is cast to form composite metal material with high reflective characteristics of corresponding oxide. Except intrinsic properties, such substrate 223 also has improved reflecting characteristics.

The amount of the reflecting units 230 in the substrate 223 is preferably not more than 15 wt. %. The effect part 210 can be prevented from high fragility due to excessive amount of the reflective units 230, thereby avoiding cracking or even direct damage caused by collision during operation.

The substrate 223 is in this embodiment may be made of plastic materials having high reflecting characteristics and the reflecting units 230 may be made of materials including pearlescent powder, mica powder or titanium dioxide. In a case of lower-temperature working environment, the substrate 223 is allowed to be made of plastic materials having high reflecting characteristics which are easy to manufacture and process. This can achieve effective light reflection with less cost, in combination with the reflecting units 230 made of materials including pearlescent powder, mica powder or titanium dioxide.

The substrate 223 is in this embodiment may also be made of metal materials having a reflectivity of not less than 30%. Metal material itself has a certain degree of reflection. In combination with the reflecting units, the effect part in this case has improved reflectivity for the light and/or heat, so that the effect part will not absorb excessive light or heat.

More preferably, the substrate 223 may be made of copper alloy such as copper or red copper, or aluminum, aluminum alloy, molybdenum alloy, stainless steel, or nickel alloy. Metals have good thermal conductivity and thus can dissipate light or heat timely.

Preferably, the reflecting units 230 in this embodiment are made of materials including at least one of titanium dioxide, zirconia, aluminum oxide, or silica. Such materials are white powders with very high melting point, which have extremely high reflectance for visible light, good thermal stability, and stable performance even under high temperature.

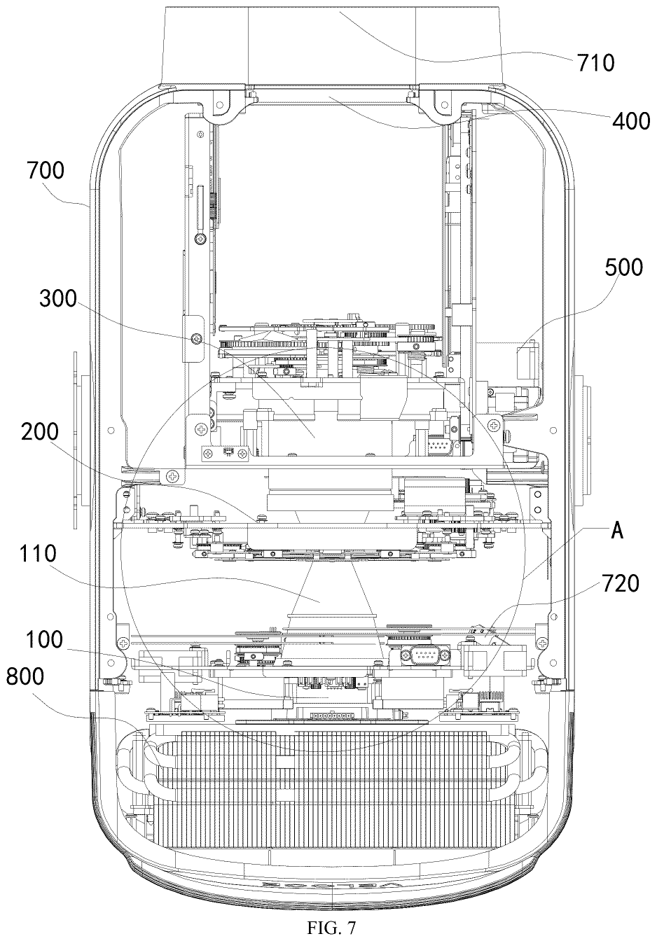

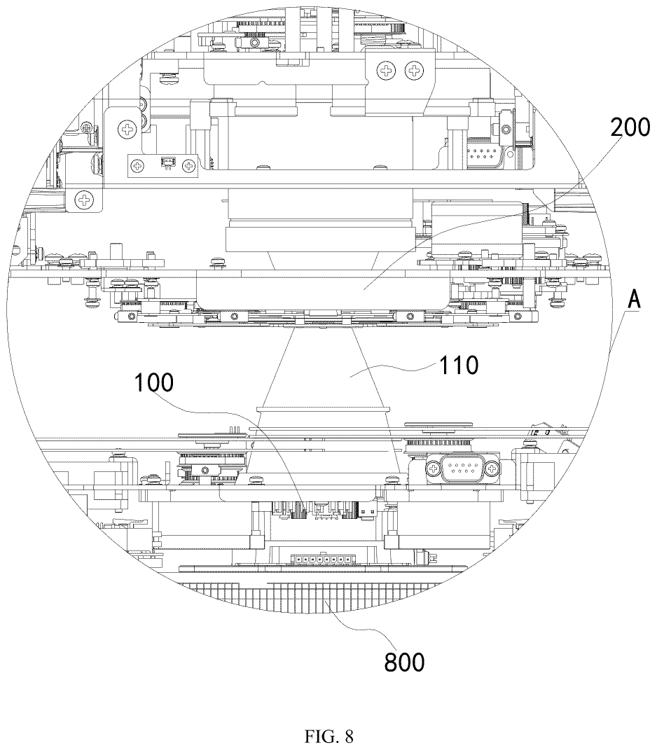

FIG. 7 and FIG. 8 provide a stage light fixture according to an embodiment of the present disclosure, including a light head 700 with a light outlet 710 and the optical system in any embodiment mentioned above. The optical system is located in the light head 700, with the light source 100 arranged at the end of the light head 700 away from the light outlet 710, and the light outlet 710 covered by the light outgoing lens 400.

With the optical system described above, portion of the light beam 110 with excessively high temperature can be reflected by the light-facing surface 211 of the effect part to various places inside the light head 700, so that the temperature inside the light head 700 is evenly distributed, and the heat inside the light head 700 is dissipated to the outside through the side wall of the light head 700, thereby achieving improved heat dissipation effect. The effect module 200 with good high-temperature resistance in the embodiment mentioned above can operate normally in the light beam 110 generated by the light source 100 at full power, overcoming the previous dilemma of needing to reduce the power of the light source 100, especially when the light source 100 has larger power.

In this embodiment, a cooling fan 720 for promoting the flow of air inside the light head 700 and a heat dissipator 800 for dissipating heat inside the light head 700 to the outside are further provided.

Furthermore, the light fixture in the present disclosure may further includes a support arm pivotally connected to the light head 700 and a base pivotally connected to the support arm, so that the light head 700 can rotate around at least two dimensions relative to the base.

Apparently, the above embodiments of the present disclosure are only examples to clearly illustrate the present disclosure, and are not intended to limit the implementation s of the present disclosure. For those skilled in the art, other changes or modifications in different forms can be made based on the above description. It is unnecessary and impossible to exhaustively enumerate all possible implementations herein. Any modifications, equivalent substitutions and improvements made within the spirit and principle of the present disclosure shall be included in the protection scope of the claims of the present disclosure.

What is claimed is:

1. An optical system, comprising:
a light source for emitting a light beam;
at least one effect module, comprising an effect part configured to at least partially switch into and out of the light beam to shape the light beam, which has a light-facing surface, close to the light source, with a reflectivity of at least 70%, and a backlight surface away from the light source;
a lens module for changing a divergence angle of the light beam; and
a light outgoing lens for projecting light spots formed by the shaped light beam.

2. The optical system according to claim 1, wherein the effect part comprises a substrate, the light-facing surface is defined by a side of the substrate close to the light source, the light-facing surface has an effect area for shaping the light beam, and the effect area is formed with a light non-transmitting portion for intercepting a portion of the light beam and a light transmitting portion for passing the other portion of the light beam; and
wherein the substrate corresponding to the light non-transmitting portion is provided with a plurality of reflecting units for at least partially reflecting light rays of the light beam and/or heat, the plurality of reflecting units are at least partially extended onto the light-facing surface from the substrate to reflect the light rays together with the substrate, and a reflectivity of each reflecting unit is greater than a reflectivity of the substrate.

3. The optical system according to claim 2, wherein the reflectivity of each reflecting unit is at least 90%.

4. The optical system according to claim 2, wherein the substrate is recessed from the light-facing surface to the backlight surface to form a plurality of accommodating holes, and the plurality of reflecting units are respectively received in the plurality of accommodating holes.

5. The optical system according to claim 2, wherein the plurality of reflecting units are in form of particles and are evenly distributed over the entire substrate.

6. The optical system according to claim 2, wherein the substrate is made of metal materials having a reflectivity of not less than 30%.

7. The optical system according to claim 2, wherein the plurality of reflecting units are made of materials including at least one of titanium dioxide, zirconia, aluminum oxide, or silica.

8. The optical system according to claim 1, wherein the light-facing surface is in form of a rough surface for diffusely reflecting the light beam.

9. The optical system according to claim 1, wherein the at least one effect module comprises a gobo wheel, a fire wheel assembly, or an aperture assembly, and the effect part is correspondingly formed by a plurality of gobos, a dynamic fire wheel, or a plurality of aperture blades.

10. The optical system according to claim 1, wherein the effect part comprises a substrate, and a reflective layer arranged on a side of the substrate close to the light source, and the light-facing surface is defined by a side of the reflective layer close to the light source.

11. The optical system according to claim 10, wherein a thickness of the reflective layer ranges from 10 μm to 100 μm.

12. The optical system according to claim 10, wherein the substrate is made of metal material or ceramic material.

13. The optical system according to claim 10, wherein the reflective layer is made of materials including at least one of barium sulfate, magnesium oxide, or polytetrafluoroethylene.

14. The optical system according to claim 10, the effect part further comprises a flexible adhesive layer arranged between the substrate and the reflective layer.

15. The optical system according to claim 10, the effect part further comprises a heat dissipation layer with an emissivity of at least 85% for an infrared band, which is arranged on a side of the substrate away from the light source.

16. The optical system according to claim 1, wherein the reflectivity of the light-facing surface is greater than 80%.

17. The optical system according to claim 1, wherein the backlight surface has a glossiness of lower than 5 GU.

18. The optical system according to claim 1, wherein the at least one effect module comprises a light shading assembly arranged close to a focal point of the light beam, and the effect part is defined by a plurality of light shading blades; and wherein the light shading assembly comprises a mounting plate with a light-passing hole around which the plurality of light shading blades are provided, and a driving module configured to drive the plurality of light shading blades to switch into or out of the light-passing hole.

19. The optical system according to claim 18, wherein the light beam is in a frustum shape, and the plurality of light shading blades are arranged on a side of the mounting plate close to the light source, and wherein the light shading assembly further comprises a plate with a first hollow hole, and a separator configured to restrict movement of the plurality of light shading blades in a direction perpendicular to a plane where the plurality of light shading blades are located, the plate is arranged on a side of the separator close to the light source and in an imaging plane of the light beam, the separator is provided with a second hollow hole for the light beam to pass through, and an opening area of the second hollow hole is 97% to 120% of a cross-sectional area of the light beam passing through the second hollow hole.

20. A stage light fixture, comprising a light head with a light outlet and the optical system according to claim 1, wherein the optical system is arranged in the light head, with the light source installed at an end of the light head away from the light outlet, and the light outlet covered by the light outgoing lens.
